(19) United States
(12) Patent Application Publication
(10) Pub. No.: US 2020/0134718 A1
(43) Pub. Date: Apr. 30, 2020

(54) GAME MONEY TRADING METHOD AND DEVICE FOR PROVIDING SAME

(71) Applicant: NEXON KOREA CORPORATION, Seongnam-si (KR)

(72) Inventor: Donggun KIM, Seongnam-si (KR)

(21) Appl. No.: 16/619,796

(22) PCT Filed: Mar. 2, 2018
(86) PCT No.: PCT/KR2018/002526

§ 371 Date: Dec. 5, 2019

(30) Foreign Application Priority Data
Jul. 18, 2017 (KR) 10-2017-0091194

(51) Int. Cl. G06Q 40/04; G06Q 20/38; G06Q 20/06; A63F 13/35

(52) U.S. Cl. CPC G06Q 40/04; G06Q 20/381; A63F 2300/53; A63F 13/35; G06Q 20/065

(57) ABSTRACT

Disclosed herein are a game money trading method and a device for providing the same. The device for providing a game money trading method includes: a communication unit configured to communicate with a user terminal and a plurality of game servers; and a control unit configured to select at least one of a plurality of game moneys corresponding to the plurality of game servers as base money, and to process the exchange of the plurality of game moneys for each other by using the base money in response to a request received from the user terminal.

### TECHNICAL FIELD

Embodiments disclosed herein relate to a game money trading method and a device for providing the same, and more specifically to the provision of a method and device which enable a user to trade different types of game money for each other.

### BACKGROUND ART

With the diversification of the fields of hobbies as well as the popularization of Internet networks, the game industry, particularly online games, have been developing. Online games are no longer merely a hobby for children or young people. In recent years, many people are playing online games regardless of their age or gender, and game research and development are more active than ever. Accordingly, online games have been developing quantitatively and qualitatively.

Among the elements of such online games, particularly, game money is one of the important elements which provide interest to users. A conventional technology related to game money is disclosed in Korean Patent Application Publication No. 10-2011-0092394. In this conventional technology, there is disclosed the provision of an exchange site which enables two or more game companies to move the game money of a third game company by means of mutual agreement.

Game money may be obtained as a result of the playing of a game by a user, or may be purchased by using cash. Within games, acts, such as the act of purchasing an item, the act of enhancing a character, or the act of purchasing a specific map, can be performed using game money, and thus game money may have important influences on the progress of games and may have monetary values.

Meanwhile, it is common for different types of game money to be used in different types of games and not to be compatible with each other. Accordingly, a user cannot use game money, obtained in any one game, in another game. In particular, when a user does not play a specific game any longer or the service of a specific game is ended, a problem arises in that the value of game money used within the corresponding game is completely lost.

Meanwhile, the above-described background technology corresponds to technical information which has been possessed by the present inventor in order to contrive the present invention or which has been acquired in the process of contriving the present invention, and can not necessarily be regarded as well-known technology which had been known to the public prior to the filing of the present invention.

### DISCLOSURE

### Technical Problem

An object of embodiments disclosed herein is to propose a method and device which enable a user to trade different types of game money for each other.

### Technical Solution

Embodiments disclosed herein select at least one of a plurality of game moneys as base money, and process the exchange of the plurality of game moneys for each other by using the base money in response to a request from a user.

### Advantageous Effects

According to any one of the above-described technical solutions, the embodiments disclosed herein can propose the game money trading method and the device for providing the same.

According to the disclosed embodiments, a user can exchange game money for another type of game money, and thus the user can flexibly manage game money according to a situation, thereby making it possible to expect the effect of increasing the degree of satisfaction of the user.

Furthermore, according to the disclosed embodiments, at least one type of game money is selected as base money based on various types of information related to games, and different types of game money are exchanged for each other using the base money, thereby making it possible to expect the effect of improving the efficiency of trading.

Moreover, according to the disclosed embodiments, the exchange rate for game money is determined based on various types of information related to games, and the exchange rate is adjusted according to a situation, thereby providing the effect of enabling reasonable trading.

The effects which can be obtained from the disclosed embodiments are not limited to the above-described effects, and other effects which have not been described above will be clearly understood by those having ordinary skill in the art, to which the present invention pertains, from the following description.

### DESCRIPTION OF DRAWINGS

FIG. 1 is a diagram showing the configuration of a system for providing a game money trading method according to an embodiment;

FIG. 2 is a diagram showing a software configuration for performing a game money trading method according to an embodiment;

FIG. 3 is a diagram showing the configuration of a device for providing a game money trading method according to an embodiment;

FIG. 4 is a view illustrating the process of checking the amount of game money held by a user and displaying it on the screen of a user terminal according to an embodiment;

FIG. 5 is a view showing a screen which is displayed on a user terminal in order to receive a request for the exchange of game moneys according to an embodiment;

FIGS. 6 to 9 are views illustrating methods of selecting base money according to embodiments;

FIG. 10 is a view showing a screen which is displayed on a user terminal in order to receive the type of game money to be sold and the amount of money to be sold according to an embodiment;

FIG. 11 is a view showing a screen which is displayed on a user terminal in order to provide information about the exchange rate between game moneys according to an embodiment;

FIGS. 12 to 16 are views illustrating methods of determining the exchange rate between game moneys according to embodiments;

FIG. 17 is a view showing a screen which is displayed on a user terminal in order to finally check whether to sell game money according to an embodiment;

FIGS. 18 and 19 are views illustrating the process of processing the exchange of game moneys according to embodiments;

FIGS. 20 to 23 are views showing screens which are displayed on a user terminal in a process of purchasing game money according to an embodiment;

FIG. 24 is a view illustrating a process of purchasing game money according to an embodiment;

FIG. 25 is a view showing a screen which is displayed on a user terminal after game money has been purchased according to an embodiment;

FIGS. 26 to 30 are views showing screens which are displayed on a user terminal during the process of selling game money in the case where a plurality of types of base money is selected according to an embodiment; and

FIG. 31 is a flowchart illustrating a method of trading game money in the case where a plurality of types of base money is selected according to an embodiment.

### BEST MODE

According to one embodiment, there is provided a device for providing a game money trading method, the device including: a communication unit configured to communicate with a user terminal and a plurality of game servers; and a control unit configured to select at least one of a plurality of game moneys corresponding to the plurality of game servers as base money, and to process the exchange of the plurality of game moneys for each other by using the base money in response to a request received from the user terminal.

According to another embodiment, there is provided a game money trading method, the method including: selecting at least one of a plurality of game moneys corresponding to a plurality of games as base money; determining the exchange rates for the plurality of game moneys to the base money; receiving a request for the exchange of game moneys from a user; and processing the requested exchange of game moneys by using the base money based on the determined exchange rates.

According to another embodiment, there is provided a computer-readable storage medium having stored thereon a program which performs a game money trading method. In this case, the game money trading method includes: selecting at least one of a plurality of game moneys corresponding to a plurality of games as base money; determining the exchange rates for the plurality of game moneys to the base money; receiving a request for the exchange of game moneys from a user; and processing the requested exchange of game moneys by using the base money based on the determined exchange rates.

According to still another embodiment, there is provided a computer program which is executed by a device for providing a game money trading method and which is stored in a storage medium to perform a game money trading method. In this case, the game money trading method includes: selecting at least one of a plurality of game moneys corresponding to a plurality of games as base money; determining the exchange rates for the plurality of game moneys to the base money; receiving a request for the exchange of game moneys from a user; and processing the requested exchange of game moneys by using the base money based on the determined exchange rates.

### MODE FOR INVENTION

Various embodiments will be described in detail below with reference to the accompanying drawings. The following embodiments may be modified to various different forms and then practiced. In order to more clearly illustrate features of the embodiments, detailed descriptions of items which are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is ‘directly connected’ to the other component but also a case where the one component is ‘connected to the other component with a third component disposed therebetween.’ Furthermore, when one component is described as “including” another component, this does not mean that the one component does not exclude the other component but means that the one component may further include the other component, unless explicitly described to the contrary.

The embodiments will be described in detail below with reference to the accompanying drawings.

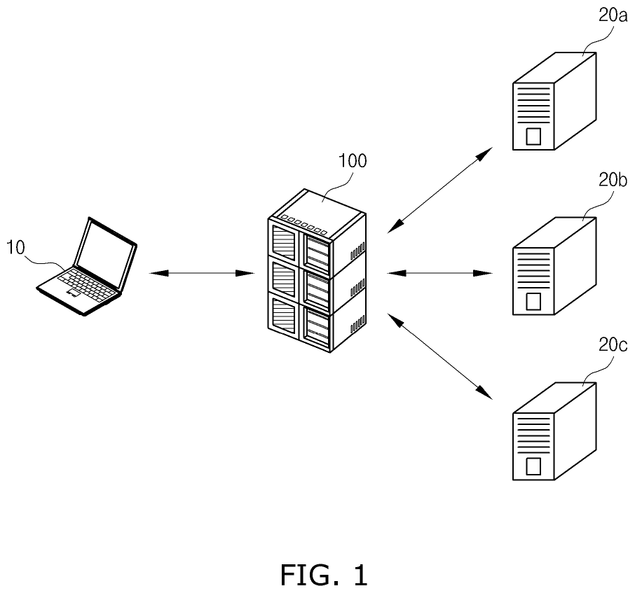

FIG. 1 is a diagram showing the configuration of a system for providing a game money trading method according to an embodiment.

In this case, the term ‘game money’ refers to virtual currency which is used within a game. In the following, it is assumed that unique game moneys are present for respective games and game moneys for different games are not compatible with each other. In other words, money for game A which is used in game A cannot be used in game B, game C, or the like.

Referring to FIG. 1, the system for providing a game money trading method may include a user terminal 10, an exchange server 100, and a plurality of game servers 20a, 20b and 20c. A user may access the exchange server 100 through the terminal 10, and may then trade game money. The exchange server 100 may communicate with the plurality of game servers 20a, 20b and 20c, and may thus transmit and receive data required for the trading of game money or transmit and receive data intended to reflect the results of the trading of game money.

For the sake of convenience, the game servers shown in FIG. 1 are referred to as a server 20a for game A, a server 20b for game B, and a server 20c for game C, respectively. Furthermore, although the number of game servers is illustrated as being three in FIG. 1, the number of game servers is not limited thereto. It will be obvious that the exchange server 100 may communicate with various numbers of game servers.

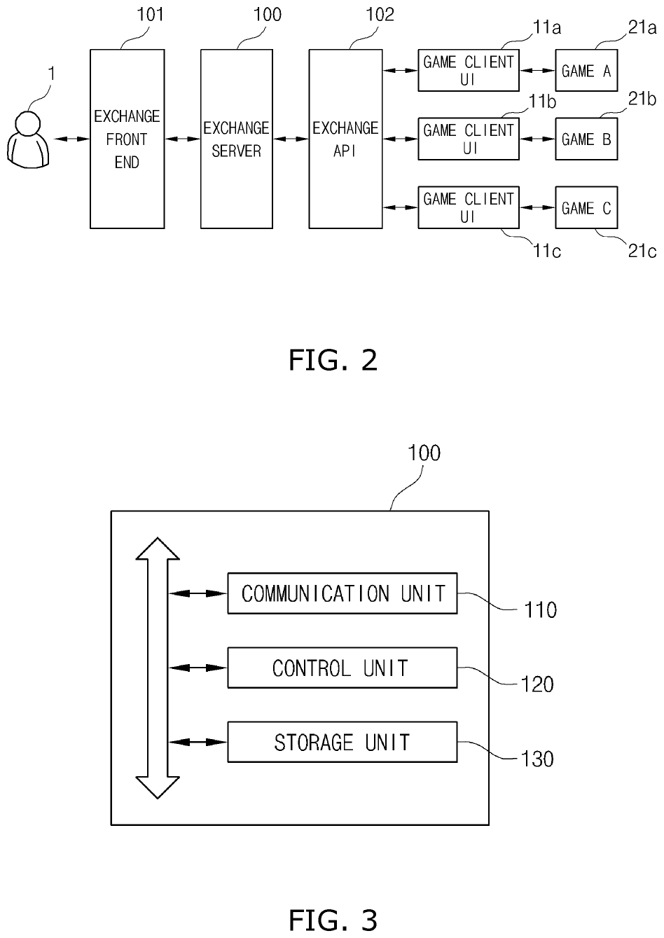

FIG. 2 is a diagram showing a software configuration for performing a game money trading method according to an embodiment. The system shown in FIG. 2 is somewhat different from the system shown in FIG. 1 in that the exchange server 100 directly communicates with the game servers 20a, 20b and 20c in the system of FIG. 1 while an exchange server 100 processes data required for the trading of game money through game client UIs 11a, 11b and 11c installed on a user terminal in the system of FIG. 2.

Referring to FIG. 2, a user 1 accesses an exchange front end 101 through a terminal, checks information required for the trading of game money, and performs input. Furthermore, the exchange server 100 invokes an exchange API 102 required for each step performed during the process of trading game money, and transmits a command to the game client UIs 11a, 11b and 11c. The game client UIs 11a, 11b and 11c having received the command respond to the exchange API 102 by transmitting data to corresponding games 21a, 21b and 21c or by obtaining data from the games 21a, 21b and 21c. In other words, the difference lies in that the tasks which are directly performed by the exchange server 100 through communication with the game servers 20a, 20b and 20c in the system of FIG. 1 are performed via the game client UIs 11a, 11b and 11c installed on the terminal of the user by invoking the exchange API 102 in the system of FIG. 2.

Although embodiments will be described based on the system shown in FIG. 1 below, it is obvious that the same embodiments may be performed by the system shown in FIG. 2. In other words, the commands or data transmitted and received between the exchange server 100 and the game servers 20a, 20b and 20c in the following embodiments may be transmitted and received between the exchange server 100 and the game client UIs 11a, 11b and 11c through the invocation of the exchange API 102.

FIG. 3 is a diagram showing the configuration of a device for providing a game money trading method according to an embodiment, i.e., the exchange server 100 of FIG. 1. Referring to FIG. 3, the exchange server 100 may include a communication unit 110, a control unit 120, and a storage unit 130.

The communication unit 110 is a component which performs wired/wireless communication with another device or a network. Accordingly, the exchange server 100 may communicate with the user terminal 10 and the game servers 20a, 20b and 20c through the communication unit 110. For this purpose, the communication unit 110 may include a communication module which supports at least one of various wired/wireless communication methods. For example, the communication module may be implemented in the form of a chipset.

In this case, the wireless communication supported by the communication unit 110 may be, for example, Wireless Fidelity (Wi-Fi), Wi-Fi Direct, Bluetooth, Ultra Wide Band (UWB), Near Field Communication (NFC), or the like. Furthermore, the wired communication supported by the communication unit 110 may be, for example, USB, High Definition Multimedia Interface (HDMI), or the like. Furthermore, the communication unit 110 may transmit data, a message, or the like to a destination over the Internet or a mobile communication network.

The control unit 120 controls the overall operation of the exchange server 100, and may include a processor, such as a CPU. According to an embodiment, the control unit 120 performs processes required during the process of trading game money. In particular, the control unit 120 selects base money which forms the basis of the trading of game money, determines the exchange rate between game moneys, and processes data attributable to the sales and purchase of game money. Detailed processes which are performed by the controller 120 will be described in detail below. In the embodiments described below, operations which are performed by the exchange server 100 are performed by the controller 120 of the exchange server 100 unless otherwise specified.

The storage unit 130 may store a program and data for the trading of the game money. In particular, the storage unit 130 may store an algorithm for selecting base money, an algorithm for determining an exchange rate, and the like.

Embodiments for providing the trading of game moneys will be described in detail with reference to the accompanying drawings. In the description of the embodiments, reference is made to FIGS. 1 and 2 when necessary.

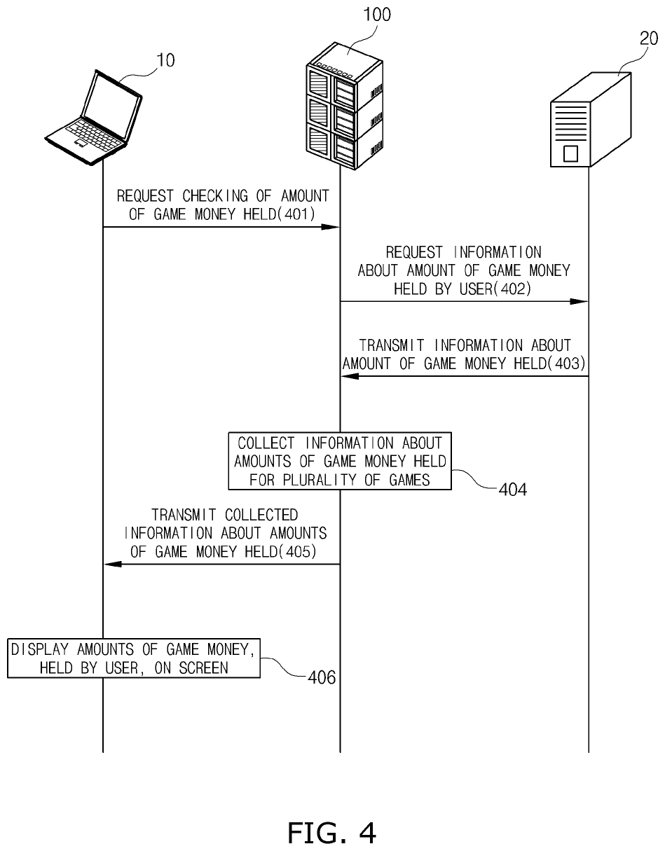

FIG. 4 is a view illustrating the process of checking the amount of game money held by a user and displaying it on the screen of a user terminal according to an embodiment. Referring to FIG. 4, at step 401, the user terminal 10 requests the exchange server 100 to check the amount of game money held by the user. At step 402, the exchange server 100 requests information about the amount of game money held by the user from a game server 20. In this case, the game server 20 is illustrated as one for the sake of convenience, but may include all of a plurality of game servers corresponding to various types of game money held by the user, which is the same in other drawings below.

When the game server 20 transmits the information about the amount of game money held by the user to the exchange server 100 at step 403, the exchange server 100 collects information about the amounts of game money held for a plurality of games at step 404. In other words, the exchange server 100 collects the amounts of game money held by the user who has requested the checking.

When the exchange server 100 transmits the collected information about the amounts of game money held to the terminal 10 at step 405, the terminal 10 may display the amounts of game money held by the user on a screen at step 406.

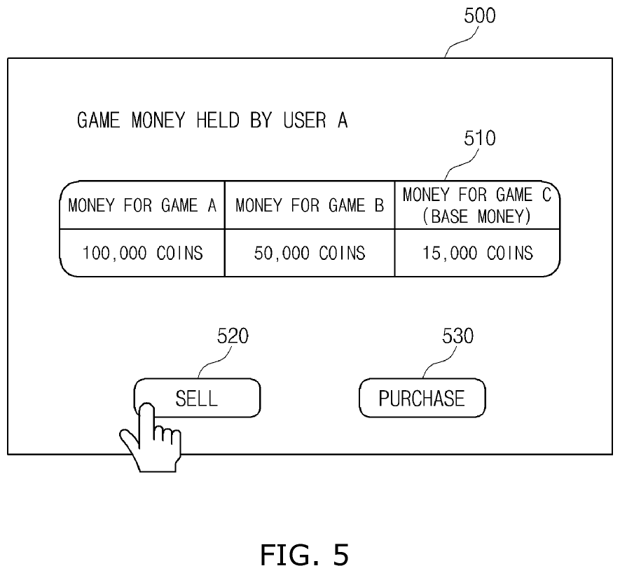

The screen which is displayed on the user terminal 10 through the above-described process is shown in FIG. 5.

The details 510 of game money held by user A are displayed on the screen 500 of FIG. 5. Referring to FIG. 5, the user A holds three types of game money, i.e., 100,000 coins in money for game A, 50,000 coins in money for game B, and 15,000 coins in money for game C. Among these, the money for game C corresponds to ‘base money.’ The term ‘base money’ refers to game money which forms the basis of the trading of game moneys. At least one of a plurality of game moneys may be selected as base money. The trading of game moneys may be performed through the base money. In other words, a user may obtain the base money by selling any one type of game money, or may purchase another type of game money by using the base money.

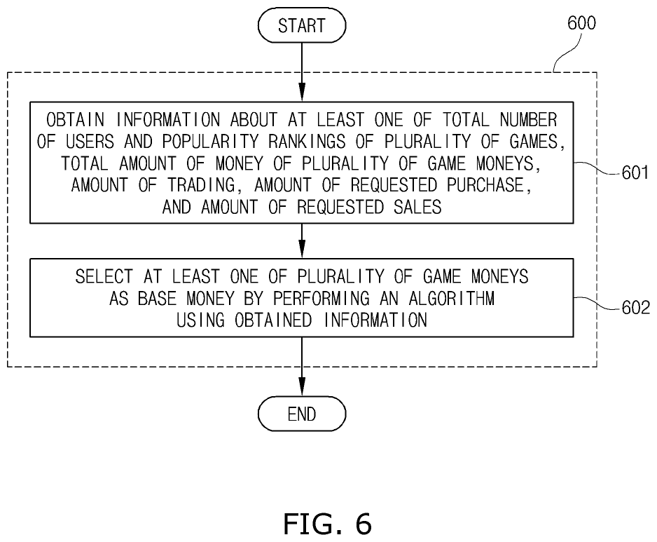

Embodiments of selecting base money will be described below with reference to FIGS. 6 to 9. FIGS. 6 to 9 are views illustrating methods of selecting base money according to the embodiments.

Referring to FIG. 6, at step 601, the exchange server 100 obtains information about at least one of the total numbers of users and popularity rankings of a plurality of games, and the total amounts of money in circulation, amounts of trading, amounts of requested purchase and amounts of requested sales of a plurality of game moneys. The exchange server 100 may obtain information about the total number of users and popularity ranking of each of the games by requesting the corresponding game server 20. In this case, ‘the total number of users’ refers to the total number of users who have created their accounts in the game and have been registered in the game. Furthermore, the exchange server 100 may obtain information about game utilization rates from the game servers 20, and may determine the popularity rankings of the games based on the obtained information. For example, the exchange server 100 may obtain information about the number of users who have played each game within a predetermined period of time, the total play times of the individual users, and the access frequencies of the individual users from a corresponding one of the game servers 20, and may determine the popularity rankings of the games based on the information.

Furthermore, the exchange server 100 may receive information about the total amount of game money in circulation from the game servers 20. Furthermore, the exchange server 100 may extract information about the amount of game money traded, the amount of requested purchase and the amount of requested sales during the process of trading game money.

At step 602, the exchange server 100 may select at least one of the plurality of game moneys as base money based on the results of the running of an algorithm using at least one of the pieces of information obtained at step 601. For example, the exchange server 100 may select game money for a game, the total number of users of which is largest, as base money, or may select game moneys for top two or more games as base money in the descending order of the total number of users. Alternatively, the exchange server 100 may select game money, the total amount of which in circulation is largest, as base money, or may select top two or more game moneys as base money in the descending order of the total amount of money in circulation. Alternatively, the exchange server 100 may select game money, the sum of the amount of trading, amount of requested purchase and amount of requested sales of which is largest, as base money. Alternatively, the exchange server 100 may select game money for a game having the highest popularity ranking as base money, or may select game moneys for top two or more games as base money in the descending order to the popularity ranking.

Alternatively, the exchange server 100 may select base money by considering all combinations including at least one of the pieces of information obtained at step 601. As described above, exchange server 100 may select base money by considering some or all of the pieces of information obtained at step 601.

In other words, the exchange server 100 may select base money based on a result obtained by substituting some or all of the pieces of information, obtained at step 601, into a preset algorithm. In this case, the algorithm may be designed such that different weights are assigned to the individual pieces of information.

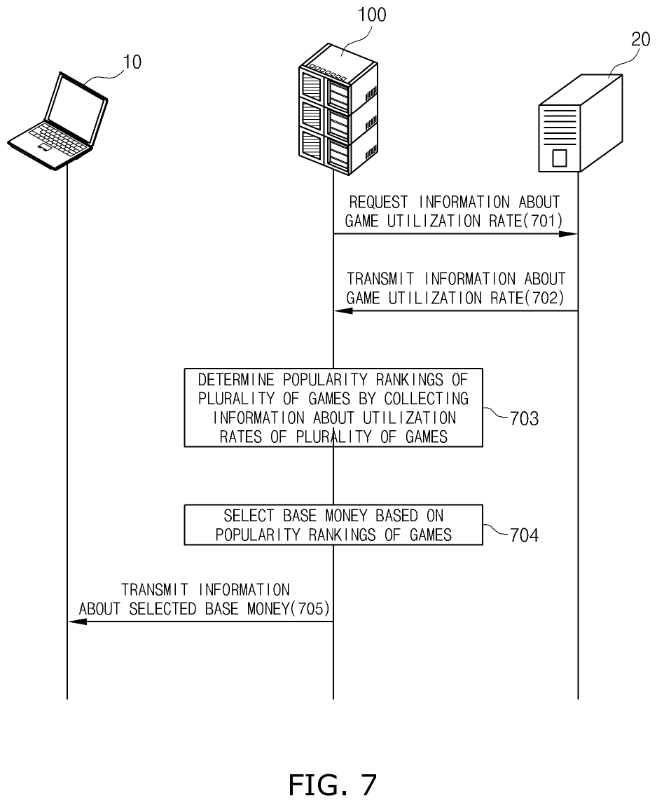

As one specific example, a process of selecting base money based on the popularity rankings of games is shown in FIG. 7. Referring to FIG. 7, the exchange server 100 requests information about the game utilization rate of each game from the game server 20 at step 701, and the game server 20 transmits the information about a game utilization rate to the exchange server 100 at step 702. In this case, the information about a game utilization rate refers to the number of users who have played the game within a predetermined period of time, the total play times of the individual users, and the access frequencies of the individual users. The information about a game utilization rate may include various types of information which can be used to determine the popularity of the game in addition to the examples proposed above.

At step 703, the exchange server 100 determines the popularity rankings of a plurality of games by collecting information about the utilization rates of the plurality of games. In this case, an algorithm for determining the popularity rankings of the games may be also designed to use at least one of various types of information in various manners.

At step 704, the exchange server 100 selects base money based on the popularity rankings of the games. For example, the exchange server 100 may select game money having the highest popularity ranking as base money, or may select all game moneys having the three highest popularity rankings as base money.

At step 705, the exchange server 100 transmits information about the selected base money to the user terminal 10.

Meanwhile, the base money may be changed after being selected. For example, the exchange server 100 may periodically change the base money, or may change the base money when a specific condition is fulfilled or a specific event occurs.

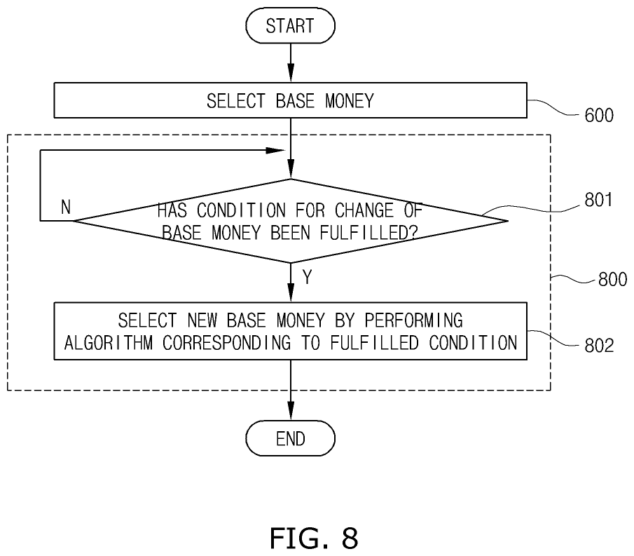

FIG. 8 is a flowchart showing a process in which base money is changed. Referring to FIG. 8, the exchange server 100 selects base money by performing step 600 of FIG. 6.

At step 801, the exchange server 100 determines whether a condition for a change of the base money has been fulfilled. For example, the exchange server 100 may determine that the condition for a change of the base money has been fulfilled when a preset predetermined period has elapsed after the selection of the base money. Alternatively, the exchange server 100 may determine that the condition for a change of the base money has been fulfilled when the amount of base money traded has been decreased below a preset reference. Alternatively, the exchange server 100 may determine that the condition for a change of the base money has been fulfilled when the popularity ranking of a game corresponding to the base money has been decreased below a predetermined value. Alternatively, the exchange server 100 may determine that the condition for a change of the base money has been fulfilled when a preset predetermined or larger number of users have requested a change of the base money. As another alternative, the exchange server 100 may set one of various conditions, and may change the base money when the set condition has been fulfilled.

When setting the condition for a change of the base money, the exchange server 100 may use at least one of the pieces of information used to select the base money at step 600. In this case, the exchange server 100 may set two or more conditions, and may determine that the condition for a change of the base money has been fulfilled when only any one of the two or more conditions has been fulfilled or when the two or more conditions have all been fulfilled.

When it is determined that the condition for a change of the base money has been fulfilled, the exchange server 100 may select new base money by running an algorithm corresponding to the fulfilled condition at step 802. In other words, the exchange server 100 may set two or more conditions for a change of the base money, and may apply an algorithm for selecting new base money which varies depending on a fulfilled condition. For this purpose, the exchange server 100 may design an algorithm corresponding to a condition for a change of the base money in advance. In this case, the algorithm may be designed to use part or all of the information used in the corresponding condition for a change of the base money, or may be designed completely regardless of the condition for a change of the base money. Alternatively, the exchange server 100 may select new base money by using the algorithm, used to select the base money at step 600, at step 802 in the same manner.

For example, when changing the base money because the total amount of base money in circulation has been decreased below a preset reference value, the exchange server 100 may check the total amounts of respective game moneys in circulation, and may select game money having the largest total amount of money in circulation as new base money. Alternatively, when changing the base money because a predetermined period has elapsed after the selection of the base money, the exchange server 100 may run an algorithm using the amounts of trading, amounts of requested purchase, and amounts of requested sales of the game moneys, and may select new base money based on the results of the running of the algorithm. Alternatively, when changing the base money because the popularity ranking of a game corresponding to the base money has been decreased below a reference value, the exchange server 100 may re-investigate the popularity rankings of the plurality of games, and may select new base money based on the popularity rankings of the games or select new base money by considering not only the popularity rankings of the games but also the amounts of requested purchase and amounts of requested sales of the game moneys.

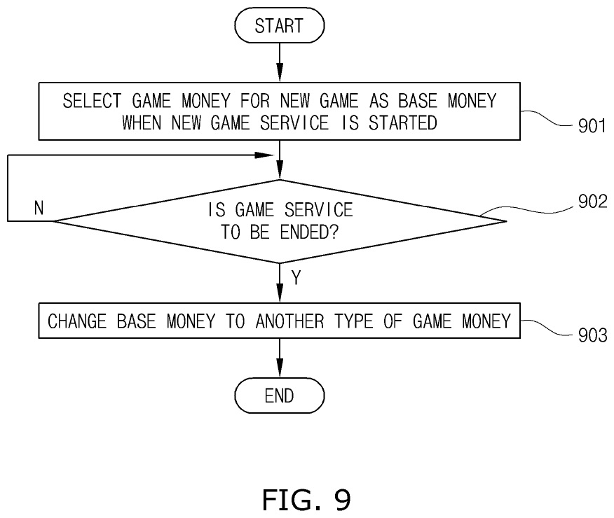

Meanwhile, when a new game is launched, the exchange server 100 may select game money for the new game as base money in order to activate the new game. Furthermore, when the service of a game corresponding to the base money is to be ended, the exchange server 100 may change the base money to another type of game money. As described above, an embodiment in which base money is selected based on the launch of a game and the end of a service is shown in FIG. 9.

Referring to FIG. 9, at step 901, when a new game service is started, the exchange server 100 selects game money for a new game as base money. Alternatively, when starting to communicate with a new game server, the exchange server 100 may select game money corresponding to the new game server as base money. In other words, when a new game server is added to a plurality of game servers with which the exchange server 100 is communicating, the exchange server 100 may select game money corresponding to the new game server as base money.

At step 902, the exchange server 100 determines whether the game service is to be ended through communication with the game servers. When, as a result of the determination, it is determined that the game service is to be ended, the exchange server 100 changes the base money to another type of game money at step 903. Alternatively, when communication with a game server which is one of the plurality of game servers and corresponds to the base money is released, the exchange server 100 may select game money, corresponding to another game server other than the game server with which communication is released, as new base money.

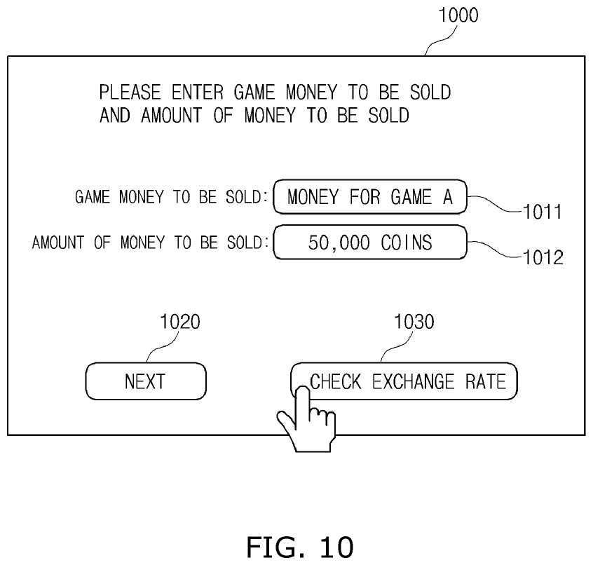

Referring back to FIG. 5, not only the details 510 of game moneys held by the user A but also a Sell button 520 and a Purchase button 530 are displayed on the screen 500. The user A may sell some of the game moneys held by him or her, or may purchase another type of game money by using some of the game moneys held by him or her. First, a process in which the user A sells game money will be described in detail below with reference to FIGS. 10 to 19.

FIG. 10 is a view showing a screen which is displayed on a user terminal in order to receive the type of game money to be sold and the amount of money to be sold according to an embodiment. Referring to FIG. 10, an entry box 1011 configured to receive the type of game money to be sold and an entry box 1012 configured to receive the amount of money to be sold are displayed on the screen 1000. Furthermore, a Next button 1020 and a Check Exchange Rate button 1030 are displayed. When the user selects the Next button 1020, the exchange server 100 immediately performs the process of selling 50,000 coins in money for game A. When the user selects the Check Exchange Rate button 1030, the exchange server 100 transmits information about the exchange rate to money for game A to the user terminal 10, and the terminal 10 displays the received information about the exchange rate on the screen thereof. In this case, the term ‘exchange rate’ refers to the exchange ratio between game moneys. In particular, the term ‘exchange rate’ may refer to the exchange value of game money, requested to be sold or purchased, to the base money. For example, the ‘exchange rate for money for game A’ refers to the amount of money for game A corresponding to one coin in base money.

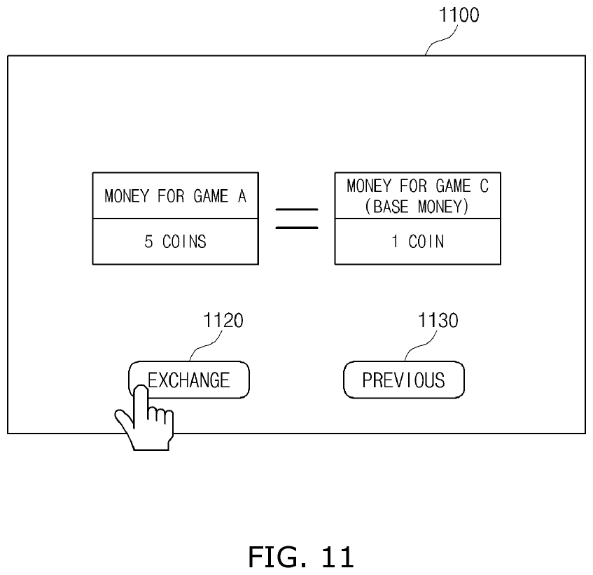

When the user selects the Check Exchange Rate button 1030 on the screen 1000 of FIG. 10, the exchange server 100 transmits information about the exchange rate for money for game A to the base money (money for game C) to the user terminal 10, and the terminal 10 displays the received information about the exchange rate on the screen thereof. The screen on which the information about the exchange rate is displayed is shown in FIG. 11.

Referring to FIG. 11, the exchange rate for money for game A to base money (money for game C) is displayed on the screen 1100. Furthermore, an Exchange button 1120 and a Previous button 1130 are displayed on the screen 1100. When the user selects the Exchange button 1120, the money for game A is exchanged for base money (money for game C) according to the exchange rate displayed on the screen 1100.

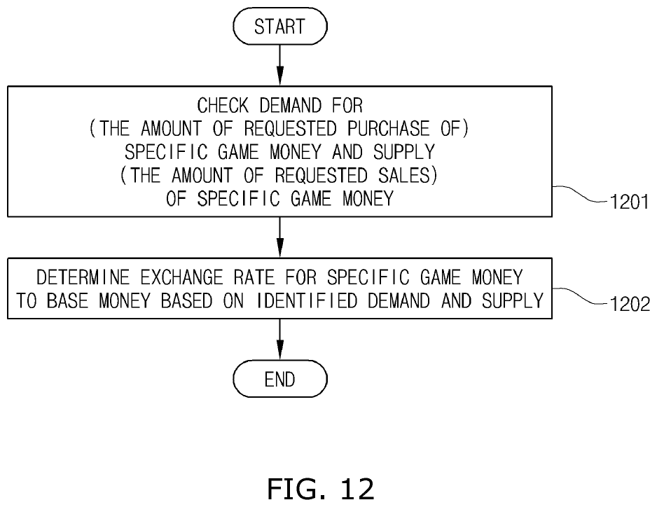

Meanwhile, the exchange server 100 may determine the exchange rate between game moneys according to various preset methods, and may adjust the exchange rate according to a situation. Embodiments in which the exchange server 100 determine and adjust an exchange rate will be described below with reference to FIGS. 12 to 16.

FIGS. 12 to 16 are views illustrating methods of determining the exchange rate between game moneys according to embodiments.

Basically, the exchange server 100 determines the exchange rate between game moneys according to the principle of supply and demand. Referring to FIG. 12, at step 1201, the exchange server 100 checks the demand for (the amount of requested purchase of) specific game money and the supply (the amount of requested sales) of the specific game money. In this case, the exchange server 100 may check the total amount of requested purchase and the total amount of requested sales accumulated so far, or may set a predetermined period and check the amount of requested purchase and the amount of requested sales accumulated within the period.

At step 1202, the exchange server 100 determines the exchange rate for specific game money to the base money based on the identified demand and supply. In this case, the exchange server 100 may design an algorithm for determining an exchange rate based on demand and supply in various manners. For example, the exchange server 100 may determine an exchange rate based on a result value calculated by substituting a value, obtained by subtracting the amount of requested sales (supply) of specific game money from the amount of requested purchase (demand) of specific game money, into a preset equation. As another alternative, the algorithm may be designed using various methods such that basically, according to the principle of demand and supply, an exchange rate decreases as the supply of game money increases and increases as the demand for the game money increases.

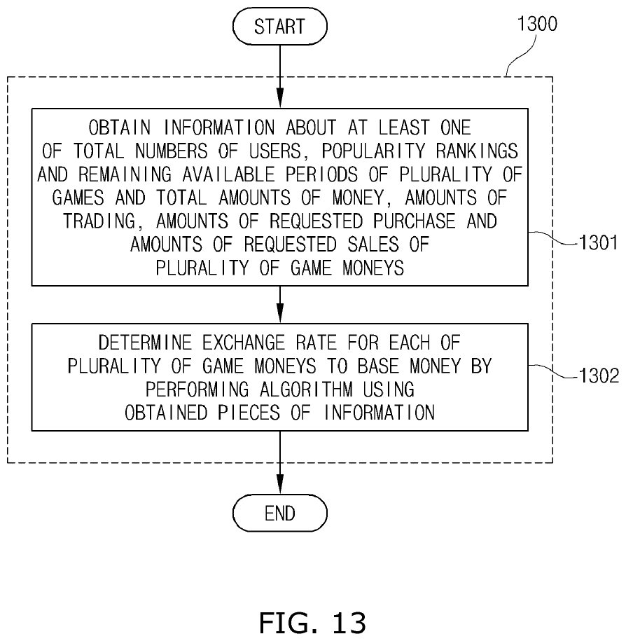

Furthermore, the exchange server 100 may determine an exchange rate using not only the amount of requested purchase and amount of requested sales of game money but also various types of information. Referring to FIG. 13, at step 1301, the exchange server 100 obtains information about at least one of the total numbers of users, popularity rankings and remaining available periods of a plurality of games, and the total amounts of money in circulation, amounts of trading, amounts of requested purchase and amounts of requested sales of a plurality of game moneys. A method by which the exchange server 100 obtains various types of information is the same as described in conjunction with step 601 of FIG. 6. In this case, the ‘remaining available period’ of a game refers to a period which remains until the end of a game service in the game scheduled for the end of the game service. The end of a game service is an event which directly influences the value of game money. Accordingly, when a game service is to be ended, a period remaining until the end of the game service may be considered in the determination of an exchange rate.

At step 1302, the exchange server 100 may determine the exchange rate for each of a plurality of game moneys to the base money based on the results of running of an algorithm using at least one of the pieces of information obtained at step 1301. For example, the exchange server 100 may determine the exchange rate for game money to be lower as the total amount of game money in circulation increases. The reason for this is that when the total amount of money in circulation is larger, the value of the game money becomes lower. Alternatively, the exchange server 100 may determine an exchange rate to be higher as the total number of users of a corresponding game increases. The reason for this is that it may be expected that when the total number of users of a specific game is larger, the demand for game money for the game increases.

As another alternative, the exchange server 100 may determine the exchange rate for game money by considering all combinations including at least one of the pieces of information obtained at step 1301. As described above, the exchange server 100 may determine the exchange rate for game money by considering some or all of the pieces of information obtained at step 1301.

In other words, the exchange server 100 may determine the exchange rate for game money based on a result value obtained by substituting some or all of the pieces of information obtained at step 1301 into a preset algorithm. In this case, the algorithm may be designed such that different weights are assigned to the respective pieces of information.

Meanwhile, the exchange server 100 may adjust the exchange rate for the game money according to a situation and a condition. For example, the exchange server 100 may periodically change the exchange rate for the game money, or may change the exchange rate for the game money when a specific condition is fulfilled or a specific event occurs.

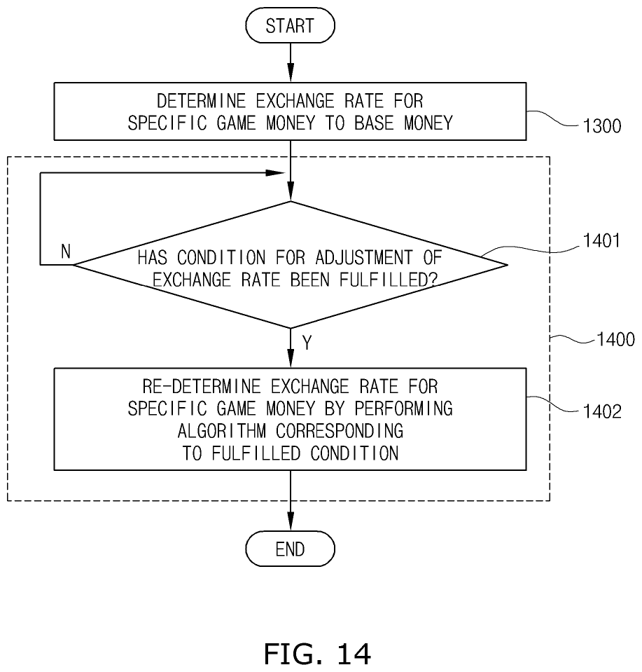

FIG. 14 is a flowchart showing a process in which an exchange rate is adjusted. Referring to FIG. 14, the exchange server 100 determines the exchange rate for game money by performing step 1300 of FIG. 13.

At step 1401, the exchange server 100 determines whether a condition for the adjustment of an exchange rate has been fulfilled. For example, the exchange server 100 may determine that the condition for the adjustment of an exchange rate has been fulfilled when a preset predetermined period has elapsed after the determination of the exchange rate for game money. Alternatively, the exchange server 100 may determine that the condition for the adjustment of an exchange rate has been fulfilled when the total amount of game money traded has been decreased below a preset reference. Alternatively, the exchange server 100 may determine that the condition for the adjustment of an exchange rate has been fulfilled when the total number of users of a corresponding game has been decreased below a preset reference. Alternatively, the exchange server 100 may determine that the condition for the adjustment of an exchange rate has been fulfilled when any one or both of the amount of requested purchase and amount of requested sales of the game money have changed by a predetermined or higher rate.

When setting the condition for the adjustment of an exchange rate, the exchange server 100 may use at least one of the pieces of information used to determine the exchange rate at step 1300. In this case, the exchange server 100 may set two or more conditions, and may determine that the condition for the adjustment of an exchange rate has been fulfilled when only any one of the two or more conditions has been fulfilled or when the two or more conditions have all been fulfilled.

When it is determined that a condition for the adjustment of an exchange rate has been fulfilled, the exchange server 100 may re-determine the exchange rate for the specific game money by running an algorithm corresponding to the fulfilled condition at step 1402. In other words, the exchange server 100 may set two or more conditions for the adjustment of an exchange rate, and may apply an algorithm for determining an exchange rate which varies depending on the fulfilled condition. For this purpose, the exchange server 100 may design the algorithm corresponding to the condition for the adjustment of an exchange rate in advance. In this case, the algorithm may be designed to use some or all of the pieces of information used in the corresponding condition for the adjustment of an exchange rate, or may be designed completely regardless of the condition for the adjustment of an exchange rate. Alternatively, the exchange server 100 may re-determine an exchange rate by using the algorithm, used to determine the exchange rate at step 1300, at step 1402 in the same manner.

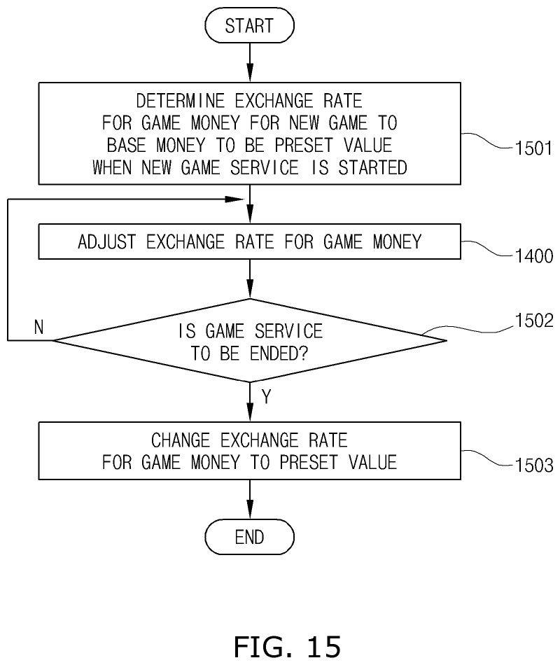

Meanwhile, when a new game is launched or a game service is to be ended, the exchange rate for game money for the corresponding game may be determined to be a preset value. An embodiment in which the exchange rate for game money is determined based on the launch of a game and the type of service is shown in FIG. 15.

Referring to FIG. 15, at step 1501, when a new game service is started, the exchange server 100 may determine the exchange rate for game money for a new game to base money to be a preset value. Alternatively, when starting to communicate with a new game server, the exchange server 100 may determine the exchange rate for game money corresponding to the new game server to be a preset value. In other words, when a new game server is added to a plurality of game servers with which the exchange server 100 is communicating, the exchange server 100 may determine the exchange rate for game money corresponding to the new game server to be the preset value.

Thereafter, the exchange server 100 may adjust the exchange rate for game money according to step 1400 of FIG. 14.

At step 1502, the exchange server 100 determines whether a game service is to be ended by communicating with the game server. When it is determined that the game service is to be ended, the process proceeds to step 1503, at which the exchange rate for game money may be changed to a preset value. In this case, the exchange server 100 may change the exchange rate when a preset predetermined period remains from the time at which a game service is to be ended. Alternatively, when communication with at least one of a plurality of game servers with which the exchange server 100 is communicating is released or data has not been received from a corresponding game server for a predetermined period, the exchange server 100 may change the exchange rate for game money corresponding to the corresponding game server to a preset value.

Meanwhile, in the embodiment shown in FIG. 15, when a new game is launched or a game service is to be ended, an exchange rate is determined to be a preset value. However, unlike in this case, the exchange server 100 designs algorithms corresponding to the launch of a new game and the end of a game service, respectively, and may change an exchange rate by performing the corresponding algorithm when a new game is launched or a game service is to be ended.

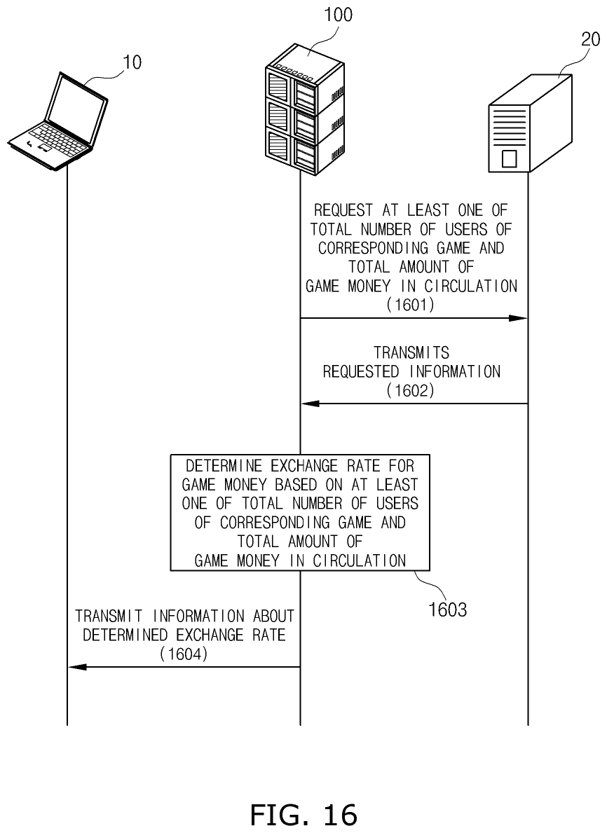

As described in conjunction with FIG. 13, exchange server 100 may determine the exchange rate for game money based on at least one of the total number of users of a corresponding game and the total amount of game money in circulation. FIG. 16 shows the embodiment of this case.

Referring to FIG. 16, at step 1601, the exchange server 100 requests at least one of the total number of users of a corresponding game and the total amount of game money in circulation from the game server 20. At step 1602, the game server 20 transmits the information, requested by the exchange server 100, to the exchange server 100. At step 1603, the exchange server 100 determines the exchange rate for game money based on at least one of the total number of users of a corresponding game and the total amount of game money in circulation. For example, the exchange server 100 may determine the exchange rate for game money to be higher as the total number of users of the game increases, and may determine the exchange rate for game money to be higher as the total amount of game money in circulation increases. At step 1604, the exchange server 100 transmits information about the determined exchange rate to the user terminal 10.

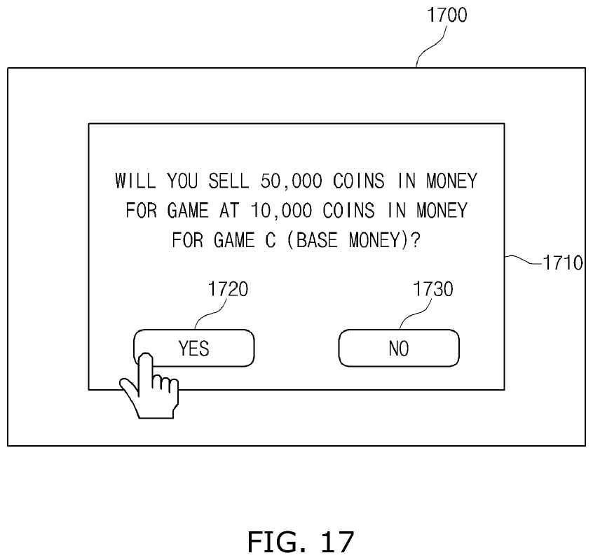

Referring back to FIG. 11, when a user selects the Exchange button 1120 on the screen 1100, the screen of FIG. 17 may be displayed on the user terminal. Referring to FIG. 17, a popup window 1710 is displayed on the screen 1700, and a Yes button 1720 and a No button 1730, together with a guide sentence for finally checking whether to sell 50,000 coins in money for game A at 10,000 coins in money for game C (base money), are displayed on the popup window 1710. When the user selects the Yes button 1720, the exchange server 100 processes the exchange of the game moneys.

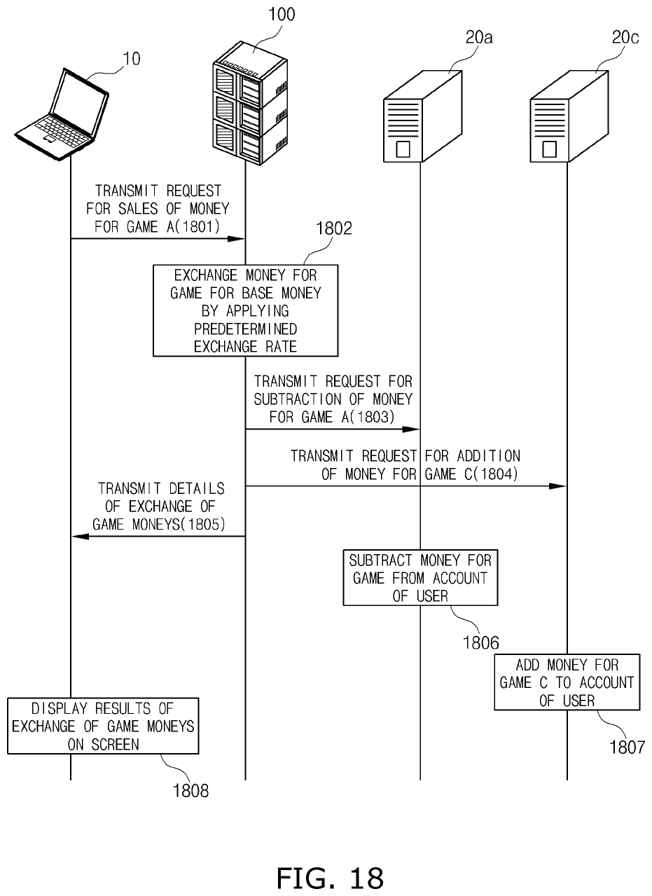

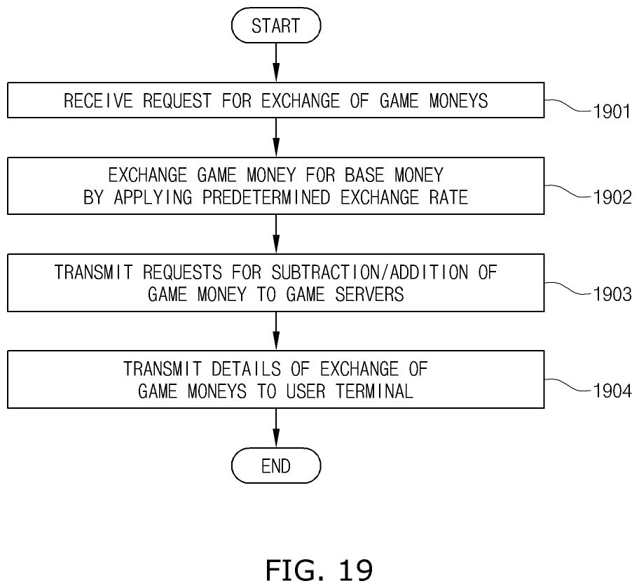

An overall process of processing the exchange of game moneys, which starts with a request for exchange from a user, will be described below with reference to FIGS. 18 and 19. FIGS. 18 and 19 are views illustrating a process of processing the exchange of game moneys according to embodiments.

Referring to FIG. 18, when the user terminal 10 transmits a request for the sales of money for game A to the exchange server 100 at step 1801, the exchange server 100 exchanges money for game A for base money (money for game C) by applying the predetermined exchange rate for the money for game A at step 1802. Thereafter, the exchange server 100 transmits a request for the subtraction of the money for game A to the game server 20a for game A at step 1803, and transmits a request for the addition of money for game C to the game server 20c for game C at step 1804. Furthermore, the exchange server 100 transmits the details of the exchange of the game moneys to the user terminal 10 at step 1805.

At step 1806, the game server 20a for game A subtracts the money for game A from the account of the user, and the server 20c for game C adds the money for game C to the account of the user. Meanwhile, the user terminal 10 displays the results of the exchange of the game moneys on a screen at step 1808.

Referring to FIG. 19, the exchange server 100 receives a request for the exchange of game moneys at step 1901, and exchanges the game money for base money by applying a predetermined exchange rate at step 1902. Thereafter, the exchange server 100 transmits requests for the subtraction/addition of the game money to the game servers at step 1903, and transmits the details of the exchange of the game moneys to the user terminal at step 1904.

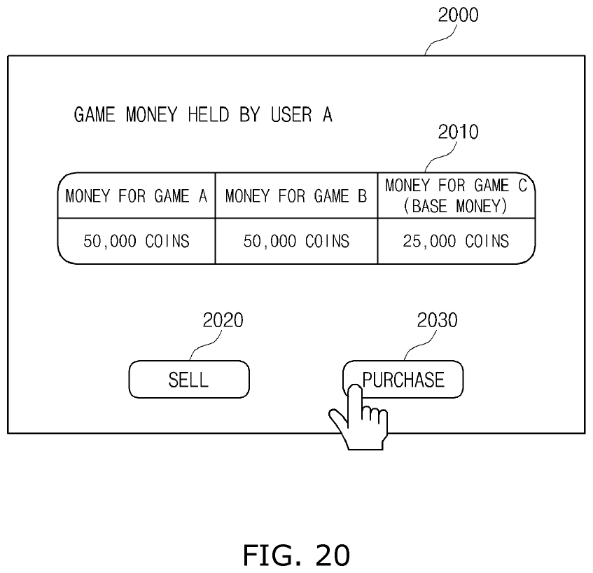

A result screen which is obtained when a user selects the Yes button 1720 in FIG. 17 and thus the exchange of the game moneys is processed is shown in FIG. 20. Referring to FIG. 20, the details 2010 of game money held by the user are displayed on a screen 2000. When this screen 2000 is compared with the screen of FIG. 5, it can be seen that money for game A has been decreased by 50,000 coins and money for game C has been increased by 10,000 coins.

The process of selling game money has been described so far. In the following, a process of purchasing game money will be described with reference to FIGS. 20 to 25.

FIGS. 20 to 23 are views showing screens which are displayed on a user terminal in a process of purchasing game money according to an embodiment.

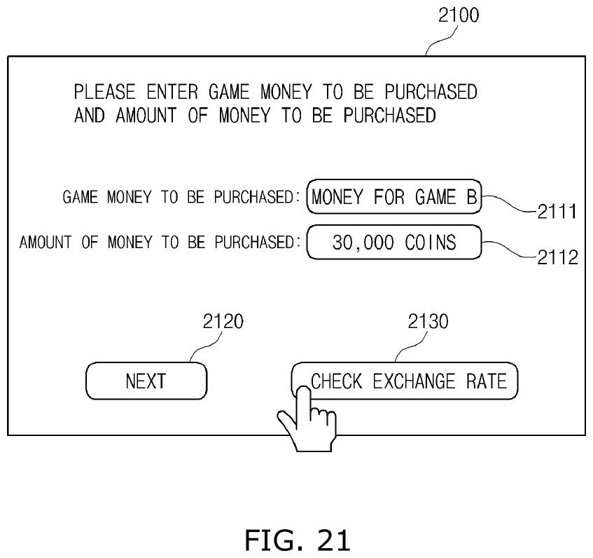

Referring to FIG. 20, the details 2010 of game money held by a user are displayed on the screen 2000, and a Sell button 2020 and a Purchase button 2030 are also displayed. When a user selects the Purchase button 2030, the screen 2100 shown in FIG. 21 is displayed.

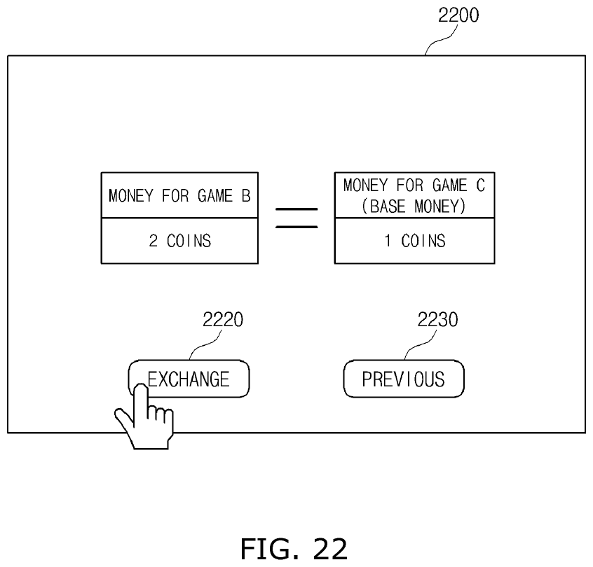

Referring to FIG. 21, an entry box 2111 configured to receive the type of game money to be purchased and an entry box 2112 configured to receive the amount of money to be purchased are displayed on the screen 2100. Furthermore, a Next button 2120 and a Check Exchange Rate button 2130 are displayed. When the user selects the Next button 2120, the exchange server 100 immediately performs the process of purchasing 30,000 coins in money for game B. When the user selects the Check Exchange Rate button 2130, the exchange server 100 transmits information about the exchange rate for the money for game B to the user terminal 10, and the terminal 10 displays the received information about an exchange rate on a screen, as shown in FIG. 22.

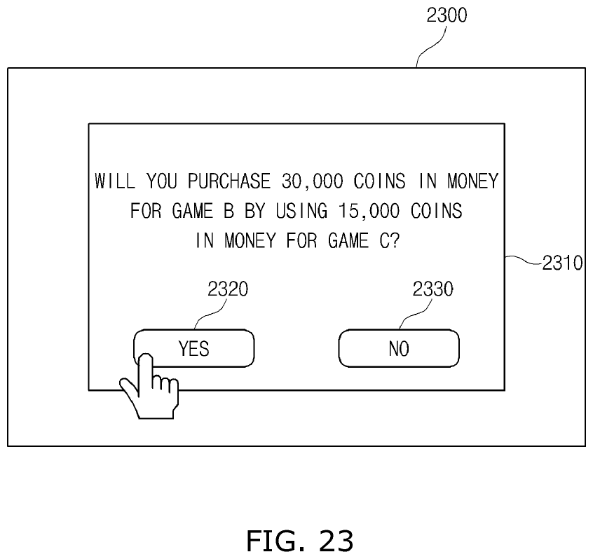

Referring to FIG. 22, the exchange rate for money for game B to base money (money for game C) is displayed on a screen 2200. Furthermore, an Exchange button 2220 and a Previous button 2230 are displayed on the screen 2200. When a user selects the Exchange button 2220, the screen 2300 of FIG. 23 may be displayed on the user terminal. Referring to FIG. 23, a popup window 2310 is displayed on the screen 2300, and a Yes button 2320 and a No button 2330, together with a guide sentence for finally checking whether to purchase 30,000 coins in money for game B by using 15,000 coins in money for game C, are displayed on the popup window 2310. When the user selects the Yes button 2320, the exchange server 100 processes the exchange of the game moneys.

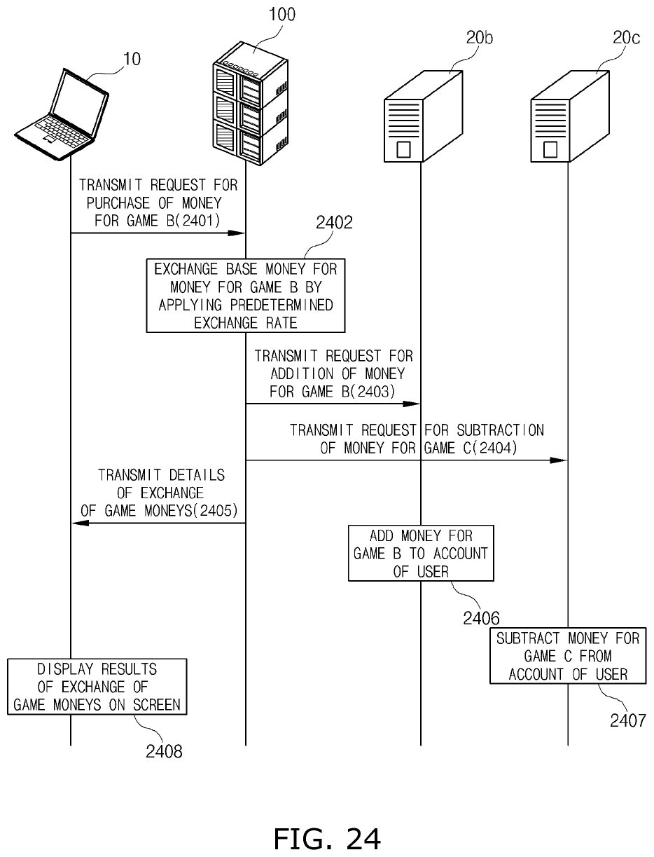

A process in which the exchange server 100 processes the purchase of game money is shown in FIG. 24. Referring to FIG. 24, when the user terminal 10 transmits a request for the purchase of money for game B to the exchange server 100 at step 2401, the exchange server 100 exchanges base money (money for game C) for money for game B by applying the predetermined exchange rate for the money for game B at step 2402. Thereafter, the exchange server 100 transmits a request for the addition of the money for game B to the game server 20b for game B at step 2403, and transmits a request for the subtraction of the money for game C to the game server 20c for game C at step 2404. Furthermore, the exchange server 100 transmits the details of the exchange of the game moneys to the user terminal 10 at step 2405.

The game server 20b for game B adds the money for game B to the account of the user at step 2406, and the server 20c for game C subtracts the money for game C from the account of the user. Meanwhile, at step 2408, the user terminal 10 displays the results of the exchange of the game moneys on a screen.

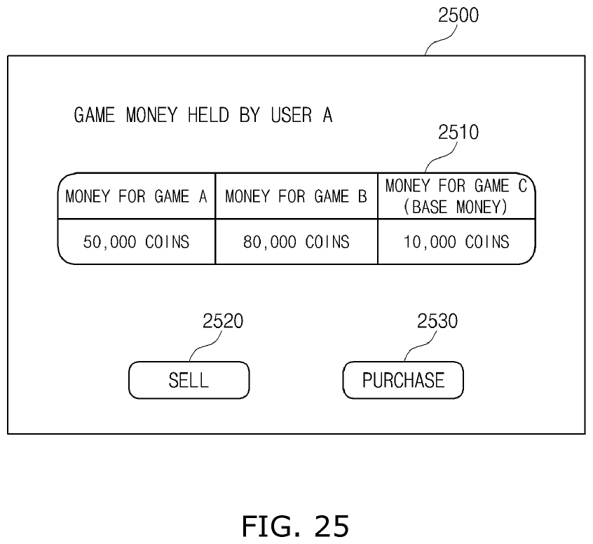

The screen which is displayed on the user terminal after the money for game B has been purchased through the above-described process is shown in FIG. 25. The details 2510 of game money held by the user are displayed on the screen 2500 of FIG. 25. When the screen 2500 is compared with the screen of FIG. 20, it can be seen that the money for game B has been increased by 30,000 coins and the money for game C has been decreased by 15,000 coins.

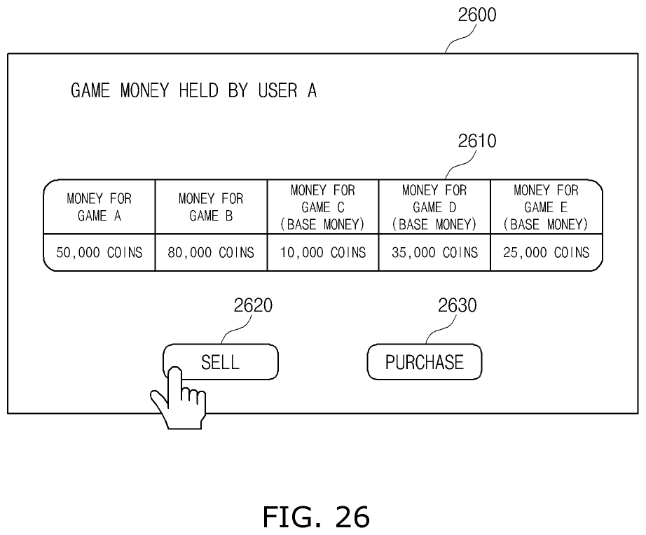

Meanwhile, as described above, the exchange server 100 may select two or more game moneys as base money. Furthermore, in the case where two or more base moneys are selected, the exchange server 100 may perform setting such that game money can be purchased or sold only when two or more base moneys are combined. For example, in the case where there are three types of base money, the exchange server 100 may perform setting such that game money can be purchased or sold only when there is used the combination in which a specific type of base money selected from the three types of base money is essentially included and at least one type of base money selected from the remaining types of base money is additionally included. This embodiment will be described in detail below with reference to FIGS. 26 to 31.

FIGS. 26 to 30 are views showing screens which are displayed on a user terminal during the process of selling game money in the case where a plurality of types of base money is selected according to an embodiment.

Referring to FIG. 26, the details 2610 of game money held by a user are displayed on a screen 2600, and a Sell button 2620 and a Purchase button 2630 are also displayed.

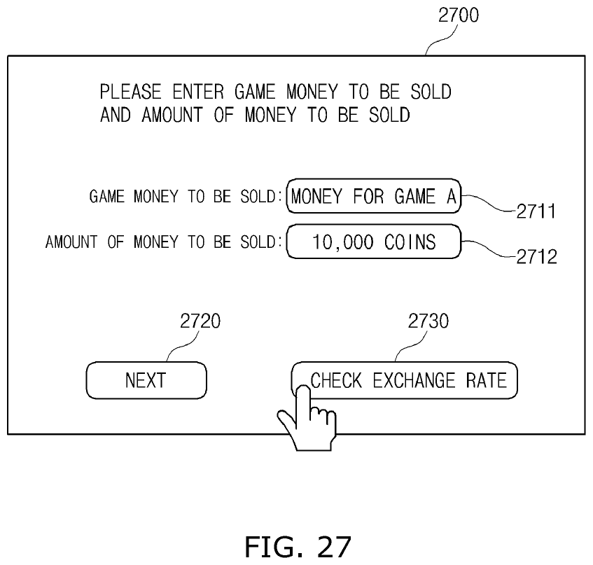

From the details 2610 of game money held by the user, it can be seen that the user holds five types of game money and three types of game money (game money C, game money D, and game money E) selected from the five types of game money are selected as base money. When the user selects the Sell button 2620, the screen 2700 of FIG. 27 is displayed on the user terminal.

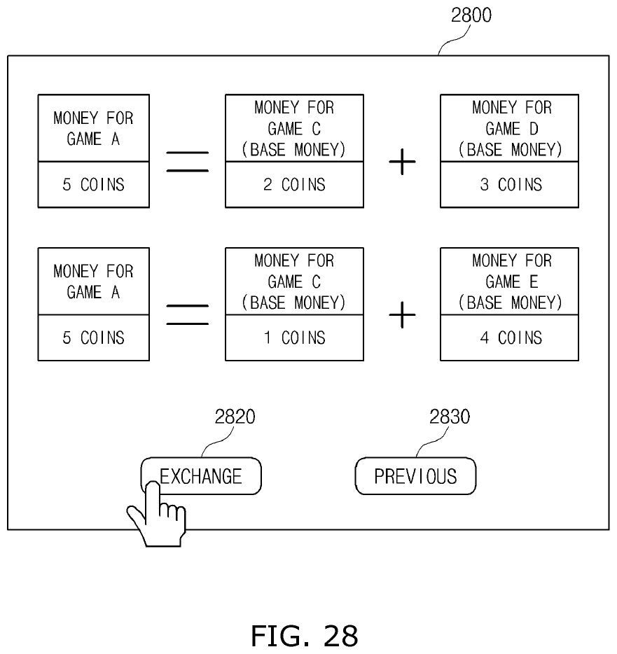

Referring to FIG. 27, an entry box 2711 for receiving the type of game money to be sold and an entry box 2712 for receiving the amount of money to be sold are displayed on the screen 2700. Furthermore, a Next button 2720 and a Check Exchange Rate button 2730 are displayed. When the user selects the Next button 2720, the exchange server 100 immediately performs the process of selling 10,000 coins in money for game A. When the user selects the Check Exchange Rate button 2730, the exchange server 100 transmits information about the exchange rate for the money for game A to the user terminal 10, and the terminal 10 displays the received information about the exchange rate on a screen. The screen on which the information about the exchange rate is displayed is shown in FIG. 28.

Referring to the screen 2800 of FIG. 28, the exchange rate for the money for game A is represented as the combination of two types of base money. 5 coins in money for game A may be exchanged for 2 coins in money for game C and 3 coins in money for game D. Alternatively, 5 coins in money for game A may be exchanged for 1 coin in money for game C and 4 coins in money for game E. As described above, the exchange server 100 may perform setting such that the exchange of game moneys is enabled only when two or more types of base money are combined. Furthermore, the exchange server 100 may perform setting such that a specific type of base money selected from the plurality of types of base money is essentially included upon the exchange of game moneys. Referring to the screen 2800 of FIG. 28, setting has been performed such that the money for game C is essentially included upon the exchange of game moneys.

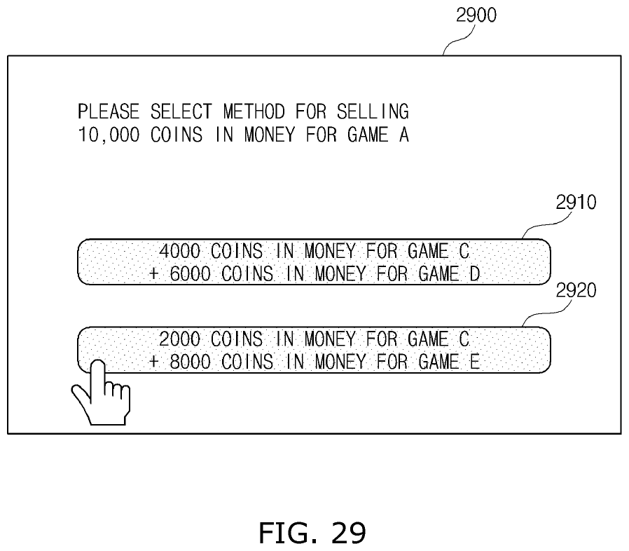

When the user selects the Exchange button 2820 on the screen 2800 of FIG. 28, the screen 2900 of FIG. 29 is displayed on the user terminal. Referring to FIG. 29, options for selecting a combination of different types of base money upon exchange are displayed as buttons 2910 and 2920 on a screen 2900. The user selects any one of two buttons 2910 and 2920, thereby selecting a combination of different types of base money which will be obtained by selling the money for game A. In FIG. 29, the user selects the button 2920 for selling the money for game A at ‘2000 coins in money for game C+8000 coins in money E game.’

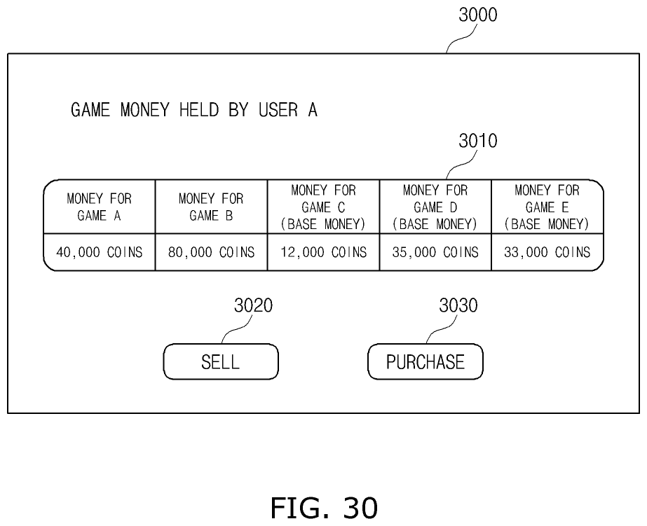

A process in which the exchange server 100 processes the exchange of game moneys in response to a request for the sales of game money from a user is similar to the process described in conjunction with FIGS. 18 and 24. A screen into which the results of the sales of the money for game A have been incorporated is shown in FIG. 30. Referring to FIG. 30, the details 3010 of game money held by the user are displayed on a screen 3000, and a Sell button 3020 and a Purchase button 3030 are also displayed. When the screen 3000 is compared with the screen 2600 of FIG. 26, it can be seen that as a result of the sales of the money for game A, the money for game A has been decreased by 10,000 coins and the money for game C and the money for game E have been increased by 2000 coins and 8000 coins, respectively.

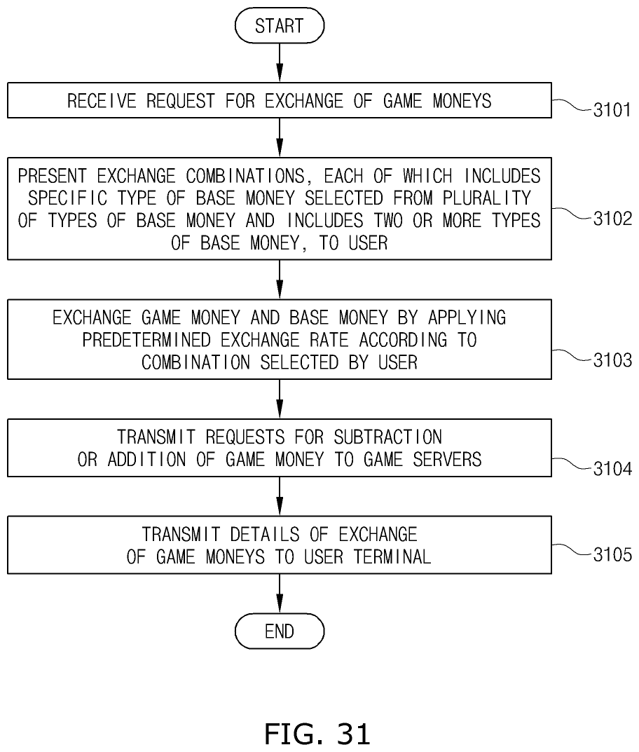

FIG. 31 is a flowchart illustrating a method of trading game money in the case where a plurality of types of base money is selected according to an embodiment.

Referring to FIG. 31, at step 3101, the exchange server 100 receives a request for the exchange of game moneys. At step 3102, the exchange server 100 transmits exchange combinations, each of which includes a specific type of base money selected from a plurality of types of base money and includes two or more types of base money, to the user terminal. When a user selects any one of the presented combinations, the exchange server 100 exchanges game money and base money by applying a predetermined exchange rate according to the combination selected by the user. At step 3104, the exchange server 100 transmits requests for the subtraction or addition of game money to the game servers. At step 3105, the exchange server 100 transmits the details of the exchange of the game moneys to the user terminal.

The term ‘unit’ used in the above-described embodiments means software or a hardware component such as a field-programmable gate array (FPGA) or application-specific integrated circuit (ASIC), and a ‘unit’ performs a specific role. However, a ‘unit’ is not limited to software or hardware. A ‘unit’ may be configured to be present in an addressable storage medium, and also may be configured to run one or more processors. Accordingly, as an example, a ‘unit’ includes components, such as software components, object-oriented software components, class components and task components, processes, functions, attributes, procedures, subroutines, segments in program code, drivers, firmware, microcode, circuits, data, a database, data structures, tables, arrays, and variables.

Components and a function provided in ‘unit(s)’ may be coupled to a smaller number of components and ‘unit(s)’ or divided into a larger number of components and ‘unit(s).’

In addition, components and ‘unit(s)’ may be implemented to run one or more CPUs in a device or secure multimedia card.

The game money trading methods according to the embodiments described in conjunction with FIGS. 4 to 31 may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the game money trading methods according to the embodiments described in conjunction with FIGS. 4 to 31 may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the game money trading methods according to the embodiments described in conjunction with FIGS. 4 to 31 may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection desired via the present specification should be defined by the attached claims, rather than the detailed description. All modifications and variations which can be derived from the meanings, scopes and equivalents of the claims should be construed as falling within the scope of the present invention.

1. A device for providing a game money trading method, the device comprising:
a communication unit configured to communicate with a user terminal and a plurality of game servers; and
a control unit configured to select at least one of a plurality of game moneys corresponding to the plurality of game servers as base money, and to process an exchange of the plurality of game moneys for each other by using the base money in response to a request received from the user terminal.

2. The device of claim 1, wherein the control unit obtains information about at least one of total numbers of users and popularity rankings of games provided by the plurality of game servers, and total amounts of money in circulation, amounts of trading, amounts of requested purchase and amounts of requested sales of the plurality of game moneys, and selects at least one of the plurality of game moneys as the base money by running an algorithm using the obtained information.

3. The device of claim 1, wherein the control unit:
determines whether a preset condition for a change of the base money has been fulfilled; and
when the condition for a change of the base money has been fulfilled, selects new base money by running a preset algorithm.

4. The device of claim 3, wherein the control unit sets the condition for a change of the base money by using at least one of total numbers of users and popularity rankings of games, and total amounts of money in circulation, amounts of trading, amounts of requested purchase and amounts of requested sales of the plurality of game moneys.

5. The device of claim 1, wherein the control unit, when a service of a new game is started, selects game money for the new game as the base money.

6. The device of claim 1, wherein the control unit determines exchange rates for the plurality of game moneys to the base money, and controls exchange based on the determined exchange rates.

7. The device of claim 6, wherein the control unit obtains information about at least one of total numbers of users, popularity rankings and remaining available periods of games provided by the plurality of game servers, and total amounts of money in circulation, amounts of trading, amounts of requested purchase and amounts of requested sales of the plurality of game moneys, and determines the exchange rates for the plurality of game moneys to the base money by running an algorithm using the obtained information.

8. The device of claim 7, wherein the control unit:
determines whether a preset condition for an adjustment of exchange rates has been fulfilled; and
when the condition for an adjustment of exchange rates has been fulfilled, adjusts the exchange rates by running a preset algorithm.

9. The device of claim 8, wherein the control unit sets the condition for an adjustment of exchange rates by using at least one of total numbers of users and popularity rankings of games, and total amounts of money in circulation, amounts of trading, amounts of requested purchase and amounts of requested sales of the plurality of game moneys.

10. The device of claim 6, wherein the control unit, when a service of a new game is started, determines an exchange rate for game money for the new game to be a preset value.

11. The device of claim 1, wherein the control unit transmits present details of game moneys held by a user to the user terminal through communication with the plurality of game servers, processes an exchange of the first game money and the base money for each other based on a predetermined exchange rate when receiving a request for a purchase or sales of first game money from the user terminal, and transmits results of the processing of the exchange to the plurality of game servers.

12. A game money trading method, the method comprising:
selecting at least one of a plurality of game moneys corresponding to a plurality of games as base money;
determining exchange rates for the plurality of game moneys to the base money;
receiving a request for an exchange of game moneys from a user; and
processing the requested exchange of game moneys by using the base money based on the determined exchange rates.

13. The method of claim 12, wherein selecting the base money comprises obtaining information about at least one of total numbers of users and popularity rankings of games provided by the plurality of game servers, and total amounts of money in circulation, amounts of trading, amounts of requested purchase and amounts of requested sales of the plurality of game moneys and selecting at least one of the plurality of game moneys as the base money by running an algorithm using the obtained information.

14. The method of claim 12, wherein determining the exchange rates comprises obtaining information about at least one of total numbers of users, popularity rankings and remaining available periods of games provided by the plurality of game servers, and total amounts of money in circulation, amounts of trading, amounts of requested purchase and amounts of requested sales of the plurality of game moneys and determining the exchange rates for the plurality of game moneys to the base money by running an algorithm using the obtained information.

15. A computer-readable storage medium having stored thereon a program which performs the method set forth in claim 12.
